(19) United States
(12) Patent Application Publication
(10) Pub. No.: US 2026/0239500 A1
(43) Pub. Date: Aug. 13, 2026

(54) Light power source

(71) Applicant: Ruben Rodriguez, El Paso, TX (US)

(72) Inventor: Ruben Rodriguez, El Paso, TX (US)

(21) Appl. No.: 18/831,693

(22) Filed: Jul. 25, 2025

Related U.S. Application Data
(60) Provisional application No. 63/732,609, filed on Aug. 29, 2024.

(51) Int. Cl. H05B 7/16; F03G 6/00; H02K 7/18

(52) U.S. Cl. CPC H05B 7/16; F03G 6/00; H02K 7/1823

(57) ABSTRACT

A light power source.

### BACKGROUND OF THE INVENTION

### 1. Field of the Invention

This invention relates to a light power source. This substitute specification contains no new matter.

### 2. Description of the Prior Art

The ability to produce electricity in an efficient and economical way especially in light of the current green energy environment is desired. Solar cells which convert radiation energy from the sun into electrical energy are widely used. Using light to heat air which turns a fan blade resulting in the production of electrical energy is not something that currently exists. Prior art such as in Publication No. US2012/0048322, Device for Converting Incident Radiation into Electrical Energy, for Uttam Ghoshal, and US Pat. No. 11,658,610, Photoelectric Energy Conversion Device, for Hsiu-Cheng Chang, attempt to utilize the technology of the present invention but fail in their complexity to achieve the result desired.

In light of the foregoing, providing a simple device which makes use of a light power source to heat air resulting in the rotation of fan blades which in turn produces electricity is desired.

### SUMMARY OF THE INVENTION

It is, therefore, an object of the present invention to provide a device that produces energy from a light power source. Other objects and advantages of the present invention will become apparent from the following detailed description when viewed in conjunction with the accompanying drawings, which set forth certain embodiments of the invention.

### BRIEF DESCRIPTION OF THE DRAWINGS

FIGS. 1 and 2 illustrates the device of the present invention depicting the light power source, fan blades, and cylindrical tube into which both are placed.

FIG. 3 is an illustration of the light collecting apparatus of the current invention.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as the basis for the claims and as a basis for teaching one skilled in the art how to make and/or use the invention.

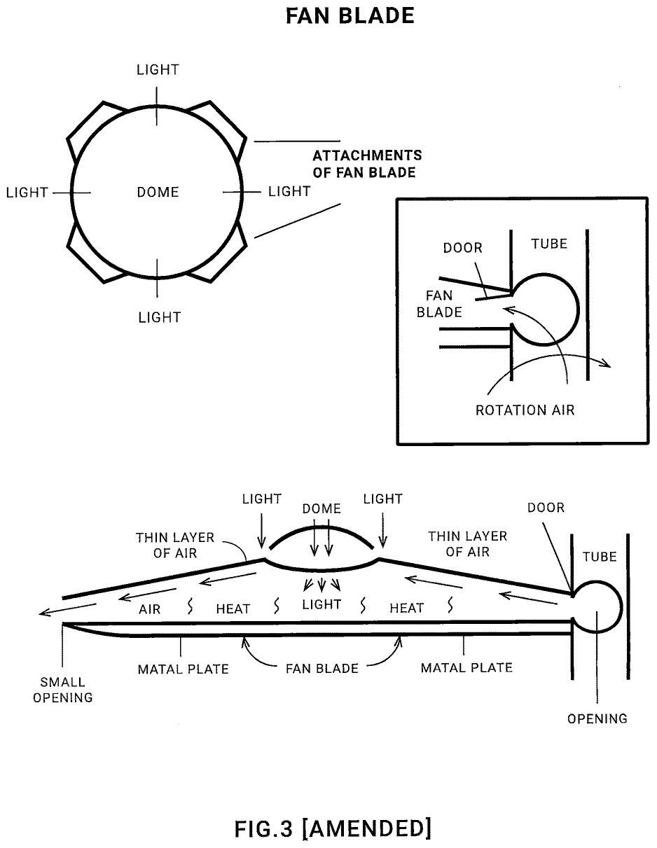

FIG. 3 illustrates a detailed depiction of the fan blade of the present invention. As shown in FIG. 3, each fan blade has a dome from which collects the energy from the light source. The fan blades are slightly pitched to assist in the rotation. A space exists between the dome and the actual blade. Air within the small space is heated by the light source. The heated air exits the small space at one end of the fan blade. Fresh air enters the small space at the other end of the fan blade. To make the reflection of the light source more efficient, the dome is coated with reflective material.

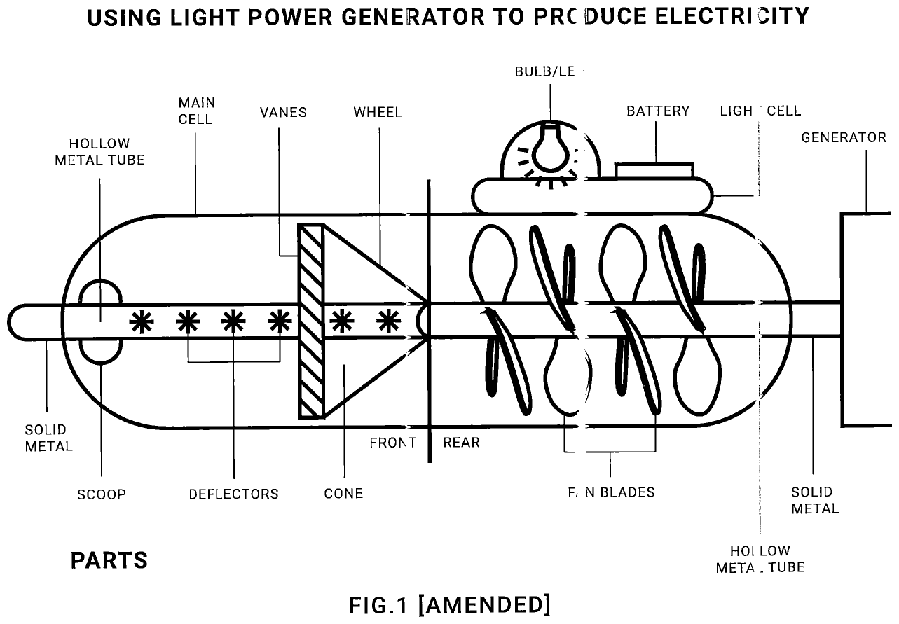

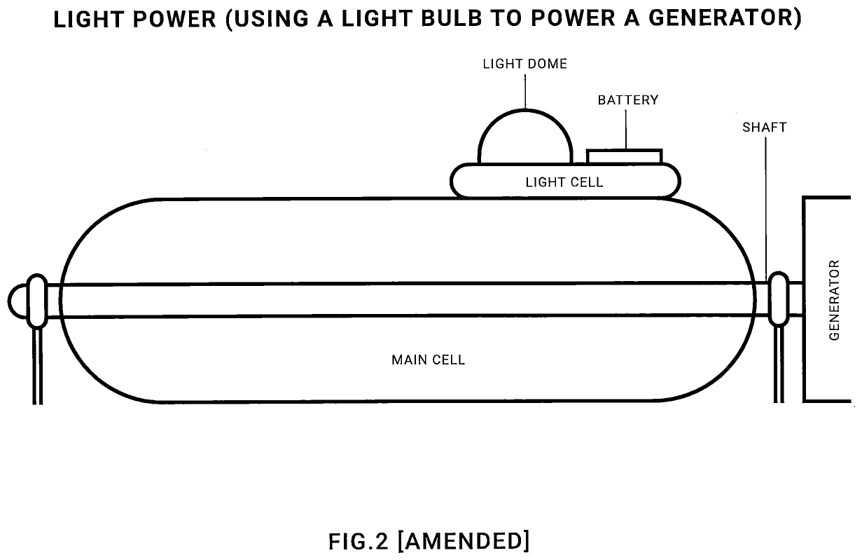

As shown in FIG. 1, the fan blades are attached to a shaft inside a cylindrical tube referred to as a cell. The shaft exits the cylindrical tube and is attached to a generator. The generator is any standard generator which will produce electricity via rotation. The light source can be any standard light source and can be powered by a battery. Multiple cells can be used together which can all be attached to a single generator shaft. A cone can be placed on the shaft to direct all light back towards the blades.

1. A light power source comprising a cylindrical tube into which a light source heats air causing fans to turn producing electricity.

2. The light power source of claim 1 wherein the fans further comprise a dome shaped collection device for collection of the light energy.

3. The light power source of claim 1 wherein a space exists between the dome and the fan blade allowing for air in said space to be heated by the light energy.

4. The light power source of claim 1 wherein the fan blades are slightly angled to improve efficiency.

5. The light power source of claim 2 wherein the dome is coated with a reflective material.

6. The light power source of claim 1 wherein the fan blades are attached to a shaft which is attached to a standard electrical generator.

7. The light power source of claim 1 wherein a cone is placed on the shaft directing all light towards the fan blades.
